(19) United States
(12) Patent Application Publication
(10) Pub. No.: US 2017/0127708 A1
(43) Pub. Date: May 11, 2017

(54) VICIA FABA PROTEIN FOOD PRODUCTS

(71) Applicant: VERSO FOOD OY, Helsini (FI)

(72) Inventor: Tarja OLLILA, Helsinki (FI)

(73) Assignee: VERSO FOD OY, Helsinki (FI)

(21) Appl. No.: 15/312,207

(22) PCT Filed: Jun. 1, 2015
(86) PCT No.: PCT/FI2015/050379

§ 371 Date: Nov. 18, 2016

(30) Foreign Application Priority Data
Jun. 3, 2014 (GB) 1409881.8

(51) Int. Cl. A23L 15/00; A23J 3/14; A23J 3/26

(52) U.S. Cl. CPC A23L 15/20; A23J 3/26; A23J 3/14; A23V 2002/00

(57) ABSTRACT

There is provided protein food products including Vicia faba and pea protein, wherein the total protein content is in the range of from 45 weight % to 55 weight % and the Vicia faba:pea protein ratio is in the range of from 1.1 to 1.8. There is also provided a process for making the disclosed protein food products.

### CROSS-REFERENCE TO RELATED APPLICATIONS

This application is a National Stage entry patent application of PCT/FI2015/050379 filed on 1 Jun. 2015 which claims Priority to GB application number 1409881.8 filed on 3 Jun. 2014.

### FIELD OF THE PRESENT DISCLOSURE

The present disclosure and embodiments included therein are directed to broad bean (Vicia faba) protein food products and processes used to make the protein food products.

### DESCRIPTION OF THE RELATED ART

A significant amount of the plant based protein is used for meat and milk production in the form of fodder (or animal feed). Fodder or animal feed is any agricultural foodstuff used specifically to feed domesticated livestock, such as cattle, goats, sheep, horses, chickens and pigs and is generally of plant origin, although some can be of animal origin as well. “Fodder” generally refers to food given to the animals (including plants cut and carried to them), rather than that which the animals forage for themselves. It generally includes hay, straw, silage, compressed and pelleted feeds, oils and mixed rations, and sprouted grains and legumes.

The worldwide animal feed industry consumed 635 million tons of feed (compound feed equivalent) in 2006, with an annual growth rate of about 2%. The use of agricultural land to grow animal feed rather than human food can be controversial; some types of feed, such as corn (maize), can also serve as human food. Those that cannot, such as grassland grass, may be grown on land that could otherwise be used for crops suitable for human consumption. Some other agricultural byproducts fed to animals may also be considered unsuitable for human consumption.

Additionally, carbon and water foot prints for animal based protein foods compared to vegetable based protein foods is significantly higher. The production of vegetable based protein foods use five times less CO₂ and two and a half times less water compared with the equal amount of animal based protein foods.

As a result, there is increasing demand for plant (vegetable) based protein foods due to the continued increase in the world's population. Also, there is the additional need to feed this ever increasing population with protein-based foods that are nutritionally balanced.

The main challenge for such plant based foods is to ensure that they allow for sufficient protein intake. An additional problem is to provide food products that have a structure, texture, color, mouth feel, etc. acceptable to consumers as well as to the food retail and manufacturing industry. For example, usage of flour is beneficial from the aspect of storage and transportation, but its uses typically tend to be narrow.

Some vegetable food products should have the proper texture to enable them to be used widely. For example, soy is mainly used in different forms (e.g. flour, textured protein) as a protein source to increase protein content in vegetable food. However, there can be a question whether or not it is produced from genetically modified organism (GMO) plants. Also, there is a growing population among consumers that have an allergic reaction towards soy protein.

As a result, there is a need to find a replacement for soy as a protein source in food.

### SUMMARY

The present disclosure relates to a protein food product comprising Vicia faba and pea protein wherein the total protein content is in the range of from about 45 weight % to about 55 weight % and the Vicia faba:pea protein ratio is in the range of from about 1.1 to about 1.8.

The present disclosure further relates to a process for making a protein food product comprising Vicia faba and pea protein comprising the steps of mixing dry ingredients comprising Vicia faba and pea protein to form a mixture; processing the mixture through an extruder; and drying the extruded material, wherein the total protein content is in the range of from about 45 weight % to about 55 weight % and the Vicia faba:pea protein ratio is in the range of from about 1.1 to about 1.8.

### BRIEF DESCRIPTION OF THE DRAWINGS

FIG. 1—Illustrates an alternative workflow/flowchart for the process of making smaller scale quantities of the protein food products of the present disclosure.

FIG. 2—Illustrates a workflow/flowchart for the process of making larger production scale quantities of the protein food products of the present disclosure.

### DETAILED DESCRIPTION

In the following specification and the claims, which follow, reference will be made to a number of terms, which shall be defined to have the following meanings.

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, is not to be limited to the precise value specified. In some instances, the approximating language may correspond to the precision of an instrument for measuring the value. The ratios given are weight ratios.

The present disclosure is generally directed toward protein food products that include Vicia faba in combination with pea protein. The protein food products may also include Vicia faba and pea protein in combination with animal-based protein including, for example, egg white.

Protein food products in the present disclosure can be used in stews, casseroles, soups, burgers, smoothies and as breakfast cereals. Such products give thicker and improved texture by binding water in the foods in which they are used.

Vicia faba, also known as the broad bean, fava bean, faba bean, field bean, bell bean, or tic bean, is a species of bean (Fabaceae) native to North Africa, Southwest and South Asia, and extensively cultivated also elsewhere. In 100 g of broad bean there is about 58.29 g of carbohydrates, 25 g of fibers, 1.53 g of fat and 26.12 g of protein. In addition broad bean has, for example, the following vitamins and nutrients (with % of daily intake recommended for adults, source USDA nutrient database):

| | | |
|---|---|---|
| Thiamine (vitamin B1) | 0.555 | mg (48%) |
| Riboflavin (vitamin B2) | 0.333 | mg (28%) |
| Niacin (vitamin B3) | 2.832 | mg (19%) |
| Vitamin B6 | 0.366 | mg (28%) |
| Folate (vitamin B9) | 423 | μg (106%) |
| Vitamin C | 4 | mg (2%) |
| Vitamin K | 9 | μg (9%) |
| Calcium | 103 | mg (10%) |
| Iron | 6.7 | mg (52%) |
| Magnesium | 192 | mg (54%) |
| Manganese | 1.626 | mg (77%) |
| Phosphorus | 421 | mg (60%) |
| Potassium | 1062 | mg (23%) |
| Sodium | 13 | mg (1%) |
| Zinc | 3.14 | mg (33%) |

Vicia faba flour is generally available or can be produced using known methods and equipment, for example, by grinding whole dried beans in a hammer mill.

Pea protein is generally available and, for example, is sold as Nutralys® F85M manufactured by Roquette France (Nutritional facts: 85% protein in dry matter).

The present disclosure relates to a protein food product comprising Vicia faba and pea protein wherein the total protein content is in the range of from about 45 weight % to about 55 weight % and the Vicia faba:pea protein ratio is in the range of from about 1.1 to about 1.8. Preferably, the amount of Vicia faba is from about 50 weight % to about 60 weight %, more preferably about 55 weight %. Preferably, the amount of pea protein is from about 35 weight % to about 45 weight %, more preferably about 40 weight %. The ratio of protein from pea protein to protein from Vicia faba is preferably from about 2.9 to about 1.8.

The protein food products may also include malt, preferably Barley malt extract, to provide, for example, improved color as well as a rounder taste and firmer texture. Barley malt extract is generally available and, for example, is sold as Maltax 40 manufactured by Senson Finland (Nutritional facts: Brix 80-82, pH 5.0-6.0, protein 4-8% in dry matter). Preferably, the amount of barley malt is 4-6 weight %, more preferably about 5 weight %.

One protein food product according this disclosure comprises 50 weight % to 60 weight % Vicia faba; 35 weight % to 45 weight % pea protein; and 4-6 weight % malt. Another possible protein food product according to this disclosure comprises about 55 weight % Vicia faba; about 40 weight % pea protein; and about 5 weight % malt.

Protein food products of the present disclosure may also include egg white as an additional protein source. Egg white powder is generally available and, for example, is sold by Bouwhuis Enthoven and by Egg Center Group (Nutritional facts: Bouwhuis Enthoven—protein content >85%, Egg Center Group—protein content 82.4%).

The present disclosure's protein food products comprising Vicia faba, pea protein and egg white have a preferable total protein content of from about 49 weight % to about 66 weight %. Preferably, the amount of Vicia faba is about 45 weight %. Preferably, the amount of pea protein is about 25 weight %. Preferably, the amount of egg white is about 25 weight %. The Vicia faba:pea protein ratio for such protein food products is preferably in the range from about from about 0.56 to about 5.80. The contribution of protein from pea protein in comparison to protein from Vicia faba is preferably from about 2.9 to about 1.8.

The present disclosure also relates to a process for making a protein food product comprising Vicia faba and pea protein comprising the steps of mixing dry ingredients comprising Vicia faba and pea protein to form a mixture, processing the mixture through an extruder and drying the extruded material. In this process, the total protein content is in the range of from 45 weight % to 55 weight % and the Vicia faba:pea protein ratio is in the range of from 1.1 to 1.8. According to an embodiment, the extrusion step further comprises separately and substantially simultaneously feeding malt to the extruder to form a malt and dry ingredients extruded material.

According to an embodiment, the extruder temperature is in the range from about 144° C. to about 147° C., preferably at about 145° C. According to another embodiment, the extruded material comprises 4-6 weight % malt, preferably the malt is barley malt extract. The dry ingredients may also comprise egg white.

According to an example, the extruded material comprises 50 weight % to 60 weight % Vicia faba; 35 weight % to 45 weight % pea protein; and 4-6 weight % malt. According to another example, the extruded material comprises about 55 weight % Vicia faba; about 45 weight % pea protein; and about 5 weight % malt. According to yet a further embodiment, the total protein content of the extruded material is in the range of from 49 weight % to 66 weight % and the Vicia faba:pea protein ratio is in the range of from 0.56 to 5.80. A further example is an extruded material comprising about 45 weight % Vicia faba; about 25 weight % pea protein; about 25 weight % egg white; and about 5 weight % malt.

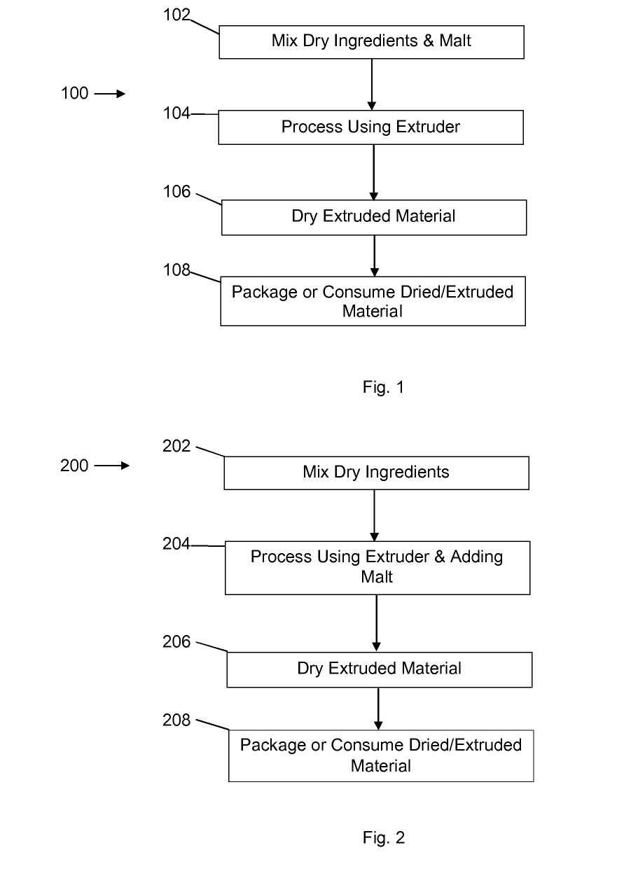

FIG. 1 and FIG. 2 illustrate the basic workflow for making the protein food products of the present disclosure. FIG. 1 illustrates an alternative process 100 for smaller scale quantities and begins by first mixing the dry ingredients (for example, Vicia faba flour, pea protein, egg white powder) and malt in step 102 using, for example, a hand mixer (for example, a Bamix® hand mixer). The resulting material (consisting of the dry ingredients and malt) is then processed through an extruder in step 104 (for example, a Clextral® BC82). In this exemplified embodiment for the extruder, the temperature setting is preferably from about 144° C. to about 147° C., the feeding speed of the material is preferably run by driving the motor with alternative current of about 14 Hz, (resulting to speed of 14/50 of the nominal speed of the motor) the feeding speed of water is preferably about 0.4 l/min, and the speed of the cutter is preferably run by driving a motor with alternative current of about 25 Hz (resulting in a speed of 25/50 of the nominal speed of the cutter). The extruded material is dried in step 106 on, for example, a belt dryer manufactured by Oy Petsmo Products Ab. In this exemplified embodiment, a belt dryer preferably has two blowers and a leveler at the starting point of the conveyor belt. The length of the belt is preferably about 5 meters and the width of the belt is preferably about 0.87 meters; the drying temperature is preferably about 51.6° C. at the beginning where a first blower is positioned and preferable about 28.5° C. at the end where a second blower is positioned; and the speed of the conveyor belt is preferably about 2 m/min. The dried material can be consumed or packaged in step 108 (for example, in a cardboard box using, for example, a Betti carton packaging machine) and stored in ambient temperature.

FIG. 2 illustrates a process 200 for larger production scale quantities and begins by first mixing the dry ingredients in step 202 (for example, Vicia faba flour, pea protein, egg white powder) using, for example, a drum mixer (for example, a model number P-100-1000 manufactured by Oy Petsmo Products Ab). The resulting material (the mixed dry ingredients) is then processed through an extruder and malt can be added in step 204, for example, by feeding it to the extruder with, for example, a separate pump while the mixed dry ingredients are fed through the extruder using conditions and equipment similar to those for smaller scale quantities. The extruded material is dried in step 206 using conditions and equipment similar to those for smaller scale quantities. The dried material can be consumed or packaged in step 208 using conditions and equipment similar to those for smaller scale quantities.

It is to be understood that the conditions described above are only given as an example and that a person skilled in the art is readily able to find out optimal conditions for the process, when using other types of machinery.

The examples and comparative examples (commonly referred to as examples below) set forth herein further describe and demonstrate embodiments within the scope of the present invention. The examples are given solely for the purpose of illustration and are not to be construed as limitations of the present invention, as many variations thereof are possible.

For each of the examples, the dry ingredients (for example, Vicia faba flour, pea protein, egg white powder) and barley malt extract (if present) were mixed with a Bamix® hand mixer. The resulting material was then processed through a Clextral® BC82 extruder, using a pillow die. The settings for the extrusion process are following:

| | At the start of | At the end of |
|---|---|---|
| | the process | the process |
| Temperature setting, ° C. | 145 | 145 |
| Temperature, ° C.: | 144 to 145 | 147 to 145 |
| Feeding speed of the flour, Hz | 14 | 14 |
| Feeding speed of water, l/min | 0.4 | 0.4 |
| Speed of the cutter, Hz | 25 | 25 |

The extruded material was dried on belt dryer (manufactured by Oy Petsmo Products Ab) and the dried material was packed.

Each of the examples was evaluated (See Table 1 for results). A dilution test was conducted on Examples 6 to 15 to find out the texture and the water binding capacity of the end product of each of these examples. The test involved 1 dl of boiling water being poured on top of 1 dl of the end product of the example in a cup. The cup contents stood for 10 minutes after which the texture of the end product was evaluated as well as the amount of water present in the cup. Grades were given from 1 (low score) to 5 (high score) based on the amount of water left in the cup after dilution and the softness of the end product (grade 1: most of the water not soaked the product and end product very soft, quite a lot of “flour” on the bottom of the cup; grade 2: still a lot of water not soaked and end product soft, some “flour” on the bottom of the cup; grade 3: still some water not soaked and end product soft, quite a little “flour” on the bottom of the cup; grade 4: all water immediately soaked and end product formed a very thick texture; and grade 5: main part of water soaked and end product formed a nice thick texture).

TABLE 1

| | | Appearance and Dilution |
|---|---|---|
| | Composition | Test Results |
| Comparative | 100% Vicia faba flour | Looked like fried minced meat & grey |
| example 1 | | in color - no dilution test conducted |
| Comparative | 90% Vicia faba flour, 10% pea | Looked like fried minced meat & grey |
| example 2 | protein F85M Roquette | in color - no dilution test conducted |
| Comparative | 85% Vicia faba flour, 15% pea | Looked like fried minced meat & grey |
| example 3 | protein F85M Roquette | in color - no dilution test conducted |
| Comparative | 98% Vicia faba flour, 2% barley | Looked like fried minced meat - |
| example 4 | malt extract Maltax 10 | no dilution test conducted |
| Comparative | 95% Vicia faba flour, 5% barley | Looked like fried minced meat - |
| example 5 | malt extract Maltax 10 | no dilution test conducted |
| Comparative | 75% Vicia faba flour, 20% pea | Dilution test made - main part |
| example 6 | protein F85M Roquette, 5% | of water did not soak into the |
| | barley malt extract Maltax 40 | end product and the end |
| | | product was forming a flour |
| | | sediment in the bottom of the |
| | | cup - the texture of the diluted |
| | | product: grade 2 |
| Comparative | 65% Vicia faba flour, 30% pea | Dilution test made - still quite |
| example 7 | protein F85M Roquette, 5% | a lot of water did not soak into |
| | barley malt extract Maltax 40 | the end product and the end |
| | | product was forming a flour |
| | | sediment in the bottom of the |
| | | cup - the texture of the diluted |
| | | product: grade 2 |
| Example 8 | 60% Vicia faba flour, 35% pea | Dilution test made - still quite |
| | protein F85M Roquette, 5% | some amount of water did not |
| | barley malt extract Maltax 40 | soak into the end product and |
| | | the end product was forming a |
| | | flour sediment in the bottom of |
| | | the cup nice thick texture - the |
| | | texture of the diluted product: grade 3 |
| Example 9 | 55% Vicia faba flour, 40% pea | Dilution test made - main part |
| | protein F85M Roquette, 5% | of water soaked into the end |
| | barley malt extract Maltax 40 | product and the end product |
| | | was forming a nice thick |
| | | texture - the texture of the |
| | | diluted product: grade 5 |
| Example 10 | 50% Vicia faba flour, 45% pea | Dilution test made - all the |
| | protein F85M Roquette, 5% | water soaked into the end |
| | barley malt extract Maltax 40 | product immediately and the |
| | | end product was forming very |
| | | thick texture - the texture of |
| | | the diluted product: grade 4 |
| Comparative | 75% Vicia faba flour, 25% egg | Dilution test made - Not hard |
| example 11 | white powder Bouwhuis | enough texture after dilution |
| | Enthoven | test: grade 3 |
| Comparative | 72.5% Vicia faba flour, 12.5% | Dilution test made - soft |
| example 12 | pea protein F85M Roquette, 12.5% | texture after dilution test: |
| | egg white powder Bouwhuis | grade 3 |
| | Enthoven, 2.5% barley malt | |
| | extract Maltax 40 | |
| Comparative | 55% Vicia faba flour, 30% pea | Dilution test made - soft |
| example 13 | protein F85M Roquette, 10% | texture after dilution test: |
| | egg white powder Bouwhuis | grade 3 |
| | Enthoven, 5% barley malt extract | |
| | Maltax 40 | |
| Comparative | 25% Vicia faba flour, 45% pea | Dilution test made - soft |
| example 14 | protein F85M Roquette, 25% | texture after dilution test: |
| | egg white powder Bouwhuis | grade 3 |
| | Enthoven, 5% barley malt extract | |
| | Maltax 40 | |
| Example 15 | 45% Vicia faba flour, 25% pea | Dilution test made - desirable |
| | protein F85M Roquette, 25% | firm texture close to the wished |
| | egg white powder Egg Center | one: grade 4 |
| | Group, 5% barley malt extract | |
| | Maltax 40 | |

Summarizing the above results, Examples 8 and 10 produced food product with preferred texture and dilution characteristics. Examples 9 and 15 produced food product with more preferred texture and dilution characteristics.

Table 2 summarizes the relative portions of the components and the components' contribution to the protein content for each of the examples.

TABLE 2

| Example/ | Relative portions (%) | | | | Contribution to protein (%) | | | | |
|---|---|---|---|---|---|---|---|---|---|
| Comparative | Vicia | Pea | Egg | | Vicia | Pea | Egg | | |
| example | faba | protein | white | Malt | faba | protein | white | Malt | Total |
| 1 | 100.0 | 0.0 | 0.0 | 0.0 | 26.10 | 0.00 | 0.00 | 0.00 | 26.10 |
| 2 | 90.0 | 10.0 | 0.0 | 0.0 | 23.49 | 8.50 | 0.00 | 0.00 | 31.99 |
| 3 | 85.0 | 15.0 | 0.0 | 0.0 | 22.19 | 12.75 | 0.00 | 0.00 | 34.94 |
| 4 | 98.0 | 0.0 | 0.0 | 2.0 | 25.58 | 0.00 | 0.00 | 0.12 | 25.70 |
| 5 | 95.0 | 0.0 | 0.0 | 5.0 | 24.80 | 0.00 | 0.00 | 0.30 | 25.10 |
| 6 | 75.0 | 20.0 | 0.0 | 5.0 | 19.58 | 17.00 | 0.00 | 0.30 | 36.88 |
| 7 | 65.0 | 30.0 | 0.0 | 5.0 | 16.97 | 25.50 | 0.00 | 0.30 | 42.77 |
| 8 | 60.0 | 35.0 | 0.0 | 5.0 | 15.66 | 29.75 | 0.00 | 0.30 | 45.71 |
| 9 | 55.0 | 40.0 | 0.0 | 5.0 | 14.36 | 34.00 | 0.00 | 0.30 | 48.66 |
| 10 | 50.0 | 45.0 | 0.0 | 5.0 | 13.05 | 38.25 | 0.00 | 0.30 | 51.60 |
| 11 | 75.0 | 0.0 | 25.0 | 0.0 | 19.58 | 0.00 | 21.25 | 0.00 | 40.83 |
| 12 | 72.5 | 12.5 | 12.5 | 2.5 | 18.92 | 10.63 | 10.63 | 0.15 | 40.32 |
| 13 | 55.0 | 30.0 | 10.0 | 5.0 | 14.36 | 25.50 | 8.50 | 0.30 | 48.66 |
| 14 | 25.0 | 45.0 | 25.0 | 5.0 | 6.53 | 38.25 | 21.25 | 0.30 | 66.33 |
| 15 | 45.0 | 25.0 | 25.0 | 5.0 | 11.75 | 21.25 | 21.25 | 0.30 | 54.55 |

1. A protein food product comprising Vicia faba and pea protein wherein the total protein content is in the range of from 45 weight % to 55 weight % and the Vicia faba:pea protein ratio is in the range of from 1.1 to 1.8.

2. The protein food product according to claim 1, comprising 4-6 weight % malt.

3. The protein food product according to claim 2, wherein the malt is barley malt extract.

4. The protein food product according to claim 2, comprising 50 weight % to 60 weight % Vicia faba; 35 weight % to 45 weight % pea protein; and 4-6 weight % malt.

5. The protein food product according to claim 4, comprising about 55 weight % Vicia faba; about 40 weight % pea protein; and about 5 weight % malt.

6. The protein food product according to claim 1, wherein the ratio of protein from pea protein to protein from Vicia faba is in the range of from 2.9 to 1.8.

7. The protein food product according to claim 1, further comprising egg white.

8. The protein food product according to claim 7, wherein the total protein content of the extruded material is in the range of from 49 weight % to 66 weight % and the Vicia faba:pea protein ratio is in the range of from 0.56 to 5.80.

9. A process for making a protein food product comprising Vicia faba and pea protein comprising the steps of
a. mixing dry ingredients comprising Vicia faba and pea protein to form a mixture;
b. processing the mixture through an extruder; and
c. drying the extruded material,
wherein the total protein content is in the range of from 45 weight % to 55 weight % and the Vicia faba:pea protein ratio is in the range of from 1.1 to 1.8.

10. The process according to claim 9, where the step b) further comprises separately and substantially simultaneously feeding malt to the extruder to form a malt and dry ingredients extruded material.

11. The process according to claim 9, wherein the extruder temperature is in the range from about 144° C. to about 147° C.

12. The process according to claim 11, wherein the extruder temperature is about 145° C.

13. The process according to claim 9, wherein the extruded material comprises 4-6 weight % malt.

14. The process according to claim 13, wherein the malt is barley malt extract.

15. The process according to claim 9, wherein the extruded material comprises 50 weight % to 60 weight % Vicia faba; 35 weight % to 45 weight % pea protein; and 4-6 weight % malt.

16. The process according to claim 15, wherein the extruded material comprises about 55 weight % Vicia faba; about 40 weight % pea protein; and about 5 weight % malt.

17. The process according to claim 9, wherein the dry ingredients comprise egg white.

18. The process according to claim 17, wherein the total protein content of the extruded material is in the range of from 49 weight % to 66 weight % and the Vicia faba:pea protein ratio is in the range of from 0.56 to 5.80.

19. The process according to claim 17, wherein the extruded material comprises about 45 weight % Vicia faba; about 25 weight % pea protein; about 25 weight % egg white; and about 5 weight % malt.
